(19) United States
(12) Patent Application Publication
(10) Pub. No.: US 2022/0167355 A1
(43) Pub. Date: May 26, 2022

(54) RESOURCE ALLOCATION IN A NETWORK SLICE

(71) Applicant: Nokia Solutions and Networks Oy, Espoo (FI)

(72) Inventors: Daniel Andrews, Chatham, NJ (US); Hans Kroener, Geislingen (DE); Siegfried Klein, Stuttgart (DE); Simon Borst, Maplewood, NJ (US); Silvio Mandelli, Tamm (DE)

(21) Appl. No.: 17/601,852

(22) PCT Filed: Apr. 15, 2019
(86) PCT No.: PCT/FI2019/050302

§ 371 Date: Oct. 6, 2021

(51) Int. Cl. H04W 72/06

(52) U.S. Cl. CPC H04W 72/06

(57) ABSTRACT

An apparatus is disclosed, the apparatus comprising means for assigning a plurality of user devices, flows and/or data bearers to a network slice of a plurality of network slices, determining whether transmissions via the network slice satisfy a target and, based on determining whether transmissions via the network slice satisfy the target, adjusting a weighted resource allocation metric associated with each user device, flow and/or data bearer of said network slice using one or more calculated offsets, the offsets being calculated so that respective weights, associated with each user device, flow or data bearer on said network slice, are adjusted such that their resource allocations are substantially proportional to their associated weight. The apparatus means may also allocate to the user devices, flows and/or data bearers, based on their respective adjusted weighted resource allocation metrics, transmission resources of the network.

### FIELD

The present specification relates to an apparatus and method for resource allocation in a network slice.

### BACKGROUND

A network may be sliced into multiple network slices. Data may be wirelessly transmitted to user devices via those network slices, such as over a common underlying physical infrastructure. Different parameters for each network slice may be used to meet different needs of the network slices.

### SUMMARY

According to a first aspect, there is provided an apparatus, comprising means for: determining whether transmissions via a network slice of a plurality of network slices satisfy a target; based on determining whether transmissions via the network slice satisfy the target, adjusting a weighted resource allocation metric associated with one or more data bearers on said network slice using one or more calculated offsets, the offsets being calculated so that respective weights, associated with each data bearer on said network slice, are adjusted such that their resource allocations are substantially proportional to their associated weight; and allocating to the data bearers, based on their respective adjusted weighted resource allocation metrics, transmission resources of the network.

In some embodiments, the associated weights may be pre-specified, e.g. by the same entity that specifies slice constraints. All of these may be given as input. They may be computed by a higher-level protocol such as the Service Data Adaptation Protocol (SDAP). Once SDAP (or another higher-level protocol) has computed these parameters, they may be passed down to a MAC layer for implementation by a scheduler. In some embodiments, a data bearer may be associated with a given user or user device. In some embodiments, a data bearer may be one of multiple data bearers associated with one user or user device. A data bearer may in some cases be referred to as a data flow.

The means may be configured to adjust the resource allocation metric, associated with each data bearer, based on adjusting the weights of each data bearer on said network slice using the same multiplicative factor.

The target may be associated with a constraint for the network slice, and the multiplicative factor may comprise at least an offset associated with the constraint.

The means may be configured to determine whether transmissions via the network slice satisfy a plurality of targets, each relating to a respective constraint for the network slice, and wherein a plurality of respective multiplicative offsets may be provided, associated with said constraints.

The means may be further configured to determine the amount by which the one or more targets is or are satisfied or not satisfied at a current time, and to determine the one or more multiplicative offsets based on the amount by which the one or more targets is or are satisfied or not satisfied at the current time.

The means may be further configured, based on determining whether transmissions via the network slice satisfy the target, to adjust a token counter value associated with the network slice, wherein adjusting the token counter value is based on a previous token counter value associated with the network slice, and to calculate the one or more offsets based on the updated token counter values.

The means may be further configured to calculate the one or more multiplicative offsets, such that they are substantially proportional to the ratio of the respective target or targets and the performance experienced by the data bearers in relation to the target or targets.

The weighted resource allocation metric may be a proportional fairness metric.

The target or targets may comprise one or more of a bit rate target, a throughput target, a latency target and a resource share target.

The means may be further configured to transmit, to the data bearers and using the allocated transmission resources, one or more network packets.

The means may be comprised in a base station radio access network (RAN) scheduler.

The means may comprise: at least one processor; and at least one memory including computer program code.

According to another aspect, there is provided a method, comprising: determining whether transmissions via a network slice of a plurality of network slices satisfy a target; based on determining whether transmissions via the network slice satisfy the target, adjusting a weighted resource allocation metric associated with one or more data bearers on said network slice using one or more calculated offsets, the offsets being calculated so that respective weights, associated with each data bearer on said network slice, are adjusted such that their resource allocations are substantially proportional to their associated weight; and allocating to the data bearers, based on their respective adjusted weighted resource allocation metrics, transmission resources of the network.

The resource allocation metric, associated with each data bearer, may be adjusted by adjusting the weights of each data bearer on said network slice using the same multiplicative factor.

The target may be associated with a constraint for the network slice, and the multiplicative factor may comprise at least an offset associated with the constraint.

The method may comprise determining whether transmissions via the network slice satisfy a plurality of targets, each relating to a respective constraint for the network slice, and wherein a plurality of respective multiplicative offsets may be provided, associated with said constraints.

The method may comprise determining the amount by which the one or more targets is or are satisfied or not satisfied at a current time, and to determine the one or more multiplicative offsets based on the amount by which the one or more targets is or are satisfied or not satisfied at the current time.

The method may comprise determining whether transmissions via the network slice satisfy the target, to adjust a token counter value associated with the network slice, wherein adjusting the token counter value is based on a previous token counter value associated with the network slice, and to calculate the one or more offsets based on the updated token counter values.

The method may further comprise calculating the one or more multiplicative offsets, such that they are substantially proportional to the ratio of the respective target or targets and the performance experienced by the data bearers in relation to the target or targets.

The weighted resource allocation metric may be a proportional fairness metric.

The target or targets may comprise one or more of a bit rate target, a throughput target, a latency target and a resource share target.

The method may comprise transmitting, to the data bearers and using the allocated transmission resources, one or more network packets.

The method may be performed in a base station radio access network (RAN) scheduler.

The method may be performed by at least one processor; and at least one memory including computer program code.

According to another aspect, there is provided a computer-readable medium storing computer-readable instructions that, when executed by a computing device, causes the computing device at least to perform: determining whether transmissions via a network slice of a plurality of network slices satisfy a target; based on determining whether transmissions via the network slice satisfy the target, adjusting a weighted resource allocation metric associated with one or more data bearers on said network slice using one or more calculated offsets, the offsets being calculated so that respective weights, associated with each data bearer on said network slice, are adjusted such that their resource allocations are substantially proportional to their associated weight; and allocating to the data bearers, based on their respective adjusted weighted resource allocation metrics, transmission resources of the network.

According to another aspect, there may be provided a non-transitory computer readable medium comprising program instructions stored thereon for performing a method, comprising: determining whether transmissions via a network slice of a plurality of network slices satisfy a target; based on determining whether transmissions via the network slice satisfy the target, adjusting a weighted resource allocation metric associated with one or more data bearers on said network slice using one or more calculated offsets, the offsets being calculated so that respective weights, associated with each data bearer on said network slice, are adjusted such that their resource allocations are substantially proportional to their associated weight; and allocating to the data bearers, based on their respective adjusted weighted resource allocation metrics, transmission resources of the network.

According to another aspect, there may be provided an apparatus comprising: at least one processor; and at least one memory including computer program code which, when executed by the at least one processor, causes the apparatus: to determine whether transmissions via a network slice of a plurality of network slices satisfy a target; based on determining whether transmissions via the network slice satisfy the target, to adjust a weighted resource allocation metric associated with one or more data bearers on said network slice using one or more calculated offsets, the offsets being calculated so that respective weights, associated with each data bearer on said network slice, are adjusted such that their resource allocations are substantially proportional to their associated weight; and to allocate to the data bearers, based on their respective adjusted weighted resource allocation metrics, transmission resources of the network.

### BRIEF DESCRIPTION OF THE DRAWINGS

Example embodiments will be described by way of non-limiting example, with reference to the accompanying drawings, in which:

FIG. 1 is a block diagram of an example communication system in which one or more embodiments may be implemented;

FIG. 2 illustrates an exemplary slicing control scheme according to one or more embodiments described herein;

FIG. 3 illustrates an example of adjusting one or more token counters according to one or more embodiments described herein;

FIG. 4 illustrates another example of adjusting one or more token counters according to one or more embodiments described herein;

FIG. 5 illustrates yet another example of adjusting one or more token counters according to one or more embodiments described herein;

FIG. 6 is a flow diagram, illustrating an exemplary method of adjusting network slices according to one or more embodiments described herein;

FIG. 7 is a graph illustrating aggregate bit rates for different algorithms, including one according to one or more embodiments described herein;

FIG. 8 is a graph illustrating resource usage for the different algorithms indicated in FIG. 7;

FIG. 9 is a graph illustrating the geometric mean of throughput for the different algorithms indicated in FIG. 7;

FIG. 10 is a graph illustrating the cumulative distribution functions produced by the different algorithms indicated in FIG. 7 in relation to a particular target;

FIG. 11 is a graph indicating a distribution of user resources experienced in different cells and with different weights;

FIG. 12 is a flow diagram illustrating an exemplary method for performing resource allocation according to one or more embodiments described herein; and

FIG. 13 is a block diagram of an example communication device according to one or more embodiments described herein.

### DETAILED DESCRIPTION

In the following description of various illustrative embodiments, reference is made to the accompanying drawings, which form a part hereof, and in which are shown by way of illustration various embodiments in which the invention may be practiced. It is to be understood that other embodiments may be utilized and structural and functional modifications may be made without departing from the scope of the present invention.

Example embodiments relate to radio access network (RAN) slicing. As will be explained, RAN slicing provides a framework for creating virtual networks and supporting applications and/or services on a common physical infrastructure with service differentiation in terms of, for example, key performance indicators or metrics (KPIs/KPMs) and service level agreements (SLAs.) There may therefore be the capability to provide guarantees, for example performance and/or service guarantees, to specific traffic classes, referred to as slices.

As used herein, a “target” may be a target in relation to providing a particular level of performance or service to a particular traffic class.

Slices may refer to particular applications or services, verticals and tenants, which may have fundamentally different statistical characteristics and/or different performance requirements, for example in terms of quality of experience (QoE) and/or quality of service (QoS.) A slice may comprise one or more flows or data bearers. A user or user device may be assigned one or more flows or data bearers, e.g. for one or more services. Each flow of a plurality of flows may comprise a different type of flow. A first flow of the plurality of flows may comprise a mobile broadband flow. A second flow of the plurality of flows may comprise an ultra-reliable low-latency communication flow.

The guarantees or targets for the slices may apply at the aggregate level for groups of flows or users and may pertain to long time periods. However, the conventional architecture for certain RAN schedulers tends only to deal with individual flows or users, with transmission resources being considered on a slot-by-slot basis, e.g. at the granularity of Transmission Time Intervals (TTIs). Guaranteeing performance and/or services for slices longer time periods, allocating resources on a slot-by-slot basis and providing fairness among competing flows or users, is something that is addressed in example embodiments.

Example embodiments relate generally to allocating or scheduling, which may be medium access control (MAC) scheduling. An objective of MAC scheduling may be to maximise an aggregate throughput utility for some utility function. This may be achieved by a scheduling algorithm which allocates resources to users, flows and/or data bearers at each time slot so as to maximise:

Σ_{iϵI}U′(Rᵢ)Sᵢ

where Sᵢ denotes a total service rate received by a user, flow or data bearer i during the time slot. The term U′(Rᵢ) may be referred to as the scheduling weight, or simply weight, and U′(Rᵢ)Sᵢ may be referred to as a scheduling metric, or simply metric. An example is the proportional fair (PF) algorithm that corresponds to utility function U(x)=log (x).

Example embodiments use data radio bearers (DRBs) as the resources to allocate, but are not limited to such.

One part of this specification describes an algorithm for determining weighted scheduling metric for slicing (SMSa) which enables slot-by-slot resource allocation decisions to be made for individual flows or users, while providing longer-term slice-level performance and/or service guarantees. This may involve the use of token counters as an intermediary between the longer-term slicing targets and slot-by-slot allocation decisions of a scheduler. In example embodiments, a scheduler is part of a network system, e.g. part of a base station, which dynamically allocates network resources to different slices. The scheduler may comprise a medium access control (MAC) scheduler. The SMSa may be computed by providing a standard metric, e.g. a proportional fair (PF) or some other alpha-fair metric, and offsetting this with an additive term based on the value or state of the token counters, which may be associated with a respective constraint. The allocation is based on a weight that forms part of the metric and may be specific to a user or user device for a given constraint within a slice. The weight may be adjusted based on whether or not current targets are met, which dynamically adjusts in one or other direction the allocation of resources towards to the target.

Another part of this specification relates to intra-slice fairness (ISF), which aims to provide that users or user devices belonging to the same slice, or set of slices, should receive a resource allocation substantially proportional to their per-user weights, as mentioned above. For example, users or user devices with the same per-user weight and allocated to the same slice or set of slices should receive substantially the same resource allocation. The term “substantially” indicates that the allocation may not be exactly the same, particularly for variable channels.

Therefore, in other embodiments, the concept of a further weighted scheduling metric for slicing (SMSm) will be described, seeking to achieve said ISF properties.

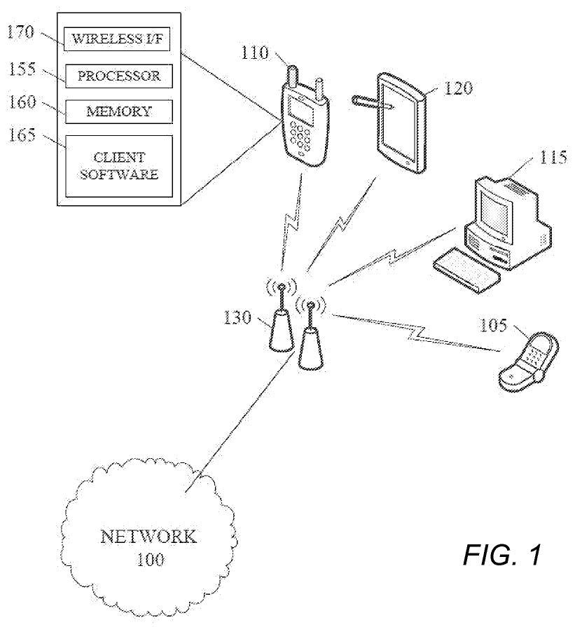

FIG. 1 illustrates an example of a system for network slicing through which various embodiments may be practiced. As seen in FIG. 1, the system may include an access node (e.g., access point (AP)) 130 and a number of wireless stations (STAs) 105, 110, 115, and 120. Orthogonal frequency division multiplexing access (OFDMA) may be used in a system for multiplexing wireless devices for uplink and/or downlink data transmissions. In OFDMA systems, a frequency spectrum is divided into a plurality of closely spaced narrowband orthogonal subcarriers. The subcarriers are then divided into mutually exclusive groups called subbands, with each subband (also referred to as subchannels) assigned to one wireless device or multiple wireless devices. According to various aspects, subcarriers may be assigned to different wireless devices. OFDMA has been adopted in synchronous and cellular systems, including 4G broadband wireless standards (e.g. Long-Term Evolution (LTE)), 5G wireless standards (e.g., New Radio (NR)), and IEEE 802.16 family standards.

In FIG. 1, the STAs may include, for example, a mobile communication device 105, mobile phone 110, personal digital assistant (PDA) or mobile computer 120, computer work station (for example, personal computer (PC)) 115, or other portable or stationary device having a wireless interface capable of communicating with an access node (e.g., access point) 130. The STAs in the system may communicate with a network 100 or with one another through the AP 130. Network 100 may include wired and wireless connections and network elements, and connections over the networks may include permanent or temporary connections. Communication through the AP 130 is not limited to the illustrated devices and may include additional mobile or fixed devices. Such additional mobile or fixed devices may include a video storage system, an audio/video player, a digital camera/camcorder, a positioning device such as a GPS (Global Positioning System) device or satellite, a television, an audio/video player, a tablet computer, a radio broadcasting receiver, a set-top box (STB), a digital video recorder, a video game console, a remote control device, a vehicle, and the like.

While one AP 130 is shown in FIG. 1, the STAs may communicate with multiple APs 130 connected to the same network 100, or to multiple networks 100. Also, while shown as a single network in FIG. 1 for simplicity, network 100 may include multiple networks that are interlinked so as to provide internetworked communications. Such networks may include one or more private or public packet-switched networks, for example the Internet, one or more private or public circuit-switched networks, for example a public switched telephone network, a satellite network, one or more wireless local area networks (e.g., 802.11 networks), one or more metropolitan area networks (e.g., 802.16 networks), and/or one or more cellular networks configured to facilitate communications to and from the STAs through one or more APs 130. In various embodiments, an STA may perform the functions of an AP for other STAs.

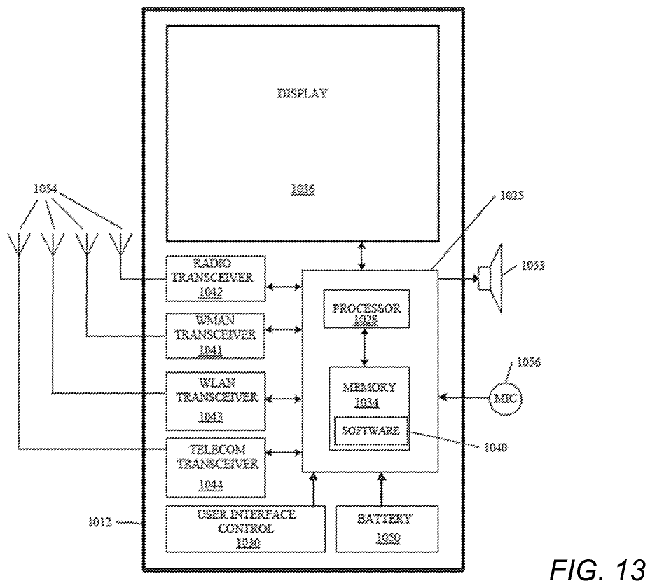

Communication between the AP and the STAs may include uplink transmissions (e.g., transmissions from an STA to the AP) and downlink transmissions (e.g., transmissions from the AP to one or more of the STAs). Uplink and downlink transmissions may utilize the same protocols or may utilize different protocols. For example, in various embodiments STAs 105, 110, 115, and 120 may include software 165 that is configured to coordinate the transmission and reception of information to and from other devices through AP 130 and/or network 100. In one arrangement, client software 165 may include specific protocols for requesting and receiving content through the wireless network. Client software 165 may be stored in computer-readable memory 16o such as read only, random access memory, writeable and rewriteable media and removable media and may include instructions that cause one or more components—for example, processor 155, wireless interface (I/F) 170, and/or a display—of the STAs to perform various functions and methods including those described herein. AP 130 may include similar software 165, memory 160, processor 155 and wireless interface 170 as the STAs. Further embodiments of STAs 105, 110, 115, and 120 and AP 130 are described below with reference to FIG. 13.

Any of the method steps, operations, procedures or functions described herein may be implemented using one or more processors and/or one or more memory in combination with machine executable instructions that cause the processors and other components to perform the method steps, procedures or functions. For example, as further described below, STAs (e.g., devices 105, 110, 115, and 120) and AP 130 may each include one or more processors and/or one or more memory in combination with executable instructions that cause each device/system to perform operations as described herein.

One or more algorithms for sharing resources among a plurality of network slices is or are described herein. The algorithms (or portions thereof) may be performed by a scheduler, such as a MAC scheduler. Algorithm(s) described herein may improve access networks, such as radio access networks (e.g., RANs, such as 4G LTE access networks, 5G access networks, etc.). The algorithm(s) may improve an aggregate utility metric (e.g., proportional fair for best-effort flows), while satisfying heterogeneous (and possibly overlapping) slice throughput or resource constraints or guarantees. The algorithm(s) may offset the nominal proportional fair scheduling weight (by additive or multiplicative terms) making it transparent to other modules of the scheduler (e.g., the MU-MIMO beam-forming functionality), except the module that performs, for example, a weight computation. The algorithms may be used to improve mobile broadband (MBB) full-buffer traffic conditions and/or ultra-reliable low-latency communication (URLLC) traffic conditions.

A network (or portions thereof) may be sliced into a plurality of virtual networks, which may run on the same physical infrastructure (e.g., an underlying physical 4G or 5G infrastructure). Each virtual network may be customized for the user(s) and/or group(s) in the virtual network. One or more users may be grouped into the same network slice. Each user in the same slice may be in a good channel condition, a bad channel condition, or other channel condition. Network slicing in a mobile network may allow a wireless network operator to assign portions of the capacity to a specific tenant or traffic class. Examples of a network slice may be, for example, traffic associated with an operator (e.g., a mobile virtual network operator (MVNO)), traffic associated with an enterprise customer, URLLC traffic, MBB traffic, verticals (e.g., for automotive applications), or other types of traffic. Network slices may have different statistical characteristics and/or different performance, quality of experience (QoE), and/or quality of service (QoS) requirements. A slice may comprise a plurality of flows. Performance or service guarantees for various slices may be defined in terms of aggregate throughput guarantees (e.g., greater than 100 megabits per second (Mbps) or less than 200 Mbps), guaranteed resource shares (e.g., greater than or less than 25% of capacity), and/or latency bounds, such as for sets of flows or users or longer time intervals (e.g., 50 ms, 50 time slots, 100 ms, 100 time slots, etc.). Resources on a slot-by-slot transmission time interval (TTI) basis may be allocated to individual flows.

URLLC traffic flows in 5G systems may have low latency requirements, such as end-to-end latencies in the single or double digit milliseconds and/or physical layer latencies in the 0.5 millisecond range. URLLC traffic flows in 5G systems may also have high reliability requirements, such as block error rates (BLERs) less than 10-5. Packet sizes in 5G URLLC flows may also be smaller (e.g., tens or hundreds of bytes in size). MBB traffic flows, on the other hand, may have different characteristics from URLLC traffic flows. Packet sizes for MBB traffic flows may be larger than packet sizes for URLLC traffic flows. For example, packet sizes for MBB traffic flows may be on the order of greater than 100 bytes. MBB traffic flows may also support higher throughput (e.g., peak throughput) or bandwidth requirements than URLLC traffic flows, in some circumstances. Latencies for MBB traffic flows (e.g., on the order of 4 milliseconds for physical layer latencies) may also be higher than latencies for URLLC traffic flows.

An operator may assign high-level performance parameters, such as slicing constraints, for each network slice or traffic class. These high-level performance requirements may be achieved through MAC resource allocation decisions, such as by a MAC scheduler, at the per-transmission time interval (TTI) granularity. Service differentiation may in be terms of key performance indicators (KPIs) and/or service level agreements (SLAs).

An operator may translate application-level requirements for the flows in a slice into the high-level slice performance parameters using a quality of experience (QoE) scheduler in an access stratum sublayer that maps flows to radio bearers (e.g., data radio bearers (DRBs)) and which specifies the quality of service (QoS) parameters for each DRB. Radio bearers, such as DRBs, may carry, for example, user data to and/or from user equipment (UEs)/STAs. A flow, such as a QoS flow, may comprise a guaranteed bit rate (GBR) flow or a non-GBR flow. A DRB may comprise a flow, or a DRB may comprise multiple flows.

A scheduler may support multiple types of slicing constraints. For example, the scheduler may meet slicing constraints by applying modifications to scheduling weights used as metrics in proportional fair schedulers or other types of schedulers.

Scheduling Metrics for Slicing (SMS)

As explained above, the major challenge in managing slicing constraints in a MAC scheduler is to make slot-by-slot resource allocation decisions for individual flows, while providing longer-term slice-level performance guarantees and fully harnessing channel variations. An SMSa algorithm which meets these requirements and which may preserve the basic structure of utility-based schedulers will now be described.

First, we formulate our scheduling model. We consider a single base station serving a set of M users. Time is divided into TTIs and the available bandwidth is divided into F frequencies, each of which is to be scheduled separately. We focus on the downlink only (although a similar problem may be considered for the uplink).

The task of the MAC scheduler in each TTI is to allocate each of the frequencies among the various users and select suitable transmission formats. Let A(f,τ) be the rate region, i.e. the set of all achievable joint rate-tuples for the various users, for frequency f in TTI τ. The set A(f, τ) depends on both f and τ because of frequency-selective and time-dependent channel conditions, and implicitly also encompasses the range of possible transmission formats (encapsulating complex physical-layer features, like multi-user MIMO (MU-MIMO) and beam-forming techniques.) A utility-based scheduler allocates frequency f in TTI τ to a (subset of the) user(s) and selects a transmission format with the aim of achieving a rate-tuple,

$$S ( f , t ) ∈ arg {max}_{S ∈ A ( f , τ )} {\sum }_{i ∈ I} W i ( τ ) {S}_{i}$$

with I={1, . . . , M} indexing the set of users and Wᵢ(τ)=U′(Rᵢ(τ)) representing the scheduling weight of user I in TTI τ. Here, U′(.) is the derivative of a concave throughput utility function U(.) and Rᵢ(τ) is a geometrically smoothed rate of user I, which is recursively calculated as Rᵢ(τ)=(1−δ) Rᵢ(τ−1)+δSᵢ(τ−1), with Si(τ)=Σ_{f=1}^{F} Si(ƒ, τ) denoting the total rate received by user I in TTI τ and δ, a small smoothing coefficient, corresponding to an averaging time window of 1/δ TTIs.

In case each frequency can only be allocated to a single user at a time, we may write Sᵢ(ƒ, τ)=I(ƒ, τ, i)Ai(ƒ, τ) with I(ƒ, τ, i) an indicator variable that equals one if, and only if, frequency f is allocated to user I in TTI τ. The selection rule in (1) then simplifies to scheduling the user on frequency f in TTI τ with the maximum value of:

Wᵢ(τ)Aᵢ(ƒ,τ).

Under mild assumptions, the above-described utility-based scheduler maximizes the overall throughput utility Σ_{iϵI} U(Rᵢ) with Rᵢ denoting the long-term average throughput of user i. In a general case, a γ-fair utility function

$${U}_{γ} ( R ) = \frac{{R}^{1 - γ}}{1 - γ}$$

for γ≠1 via the weights Wᵢ(τ)=(Rᵢ(τ))^{-γ}. For γ=1, we obtain the well-known proportional fair (PF) scheduling function U(R)=log R and if γ=0, we obtain the maximum throughput (MT) function.

If we assume that the slicing constraints are provided as input, and specified for example in terms of aggregate rate targets and/or resource guarantees, the aggregate rate targets may be indexed by a set J, and constraint jϵJ is defined by non-negative coefficients (α_{i,j})_{iϵI} and lower and upper limits βⱼ^{min} and βⱼ^{max}, taking the form:

βⱼ^{min}≤α_{i,j}Rᵢ(τ)≤βⱼ^{max}

at all TTIs τ, with possibly βⱼ^{min}=0 or βⱼ^{max}=∞. There is a natural special case in which each constraint j is defined in terms of the set of users Iⱼ⊆I that belong to a slice, with α_{i,j}=1 if iϵIⱼ and α_{i,j}=0 otherwise.

The resource guarantees for the various slices are specified in terms of variables representing the smoothed amount of resources allocated to user i, which can be tracked as:

Xᵢ(τ)=1−δXᵢ(τ−1)+δΣ_{f=1}^{F}Yᵢ(θ,τ−1)

with Yᵢ(ƒ, τ−1) representing the fraction of frequency f allocated to user i in TTI τ. In case each frequency can only be allocated to a single user at a time, Yᵢ(ƒ, τ−1)=I(ƒ, t, i.) Specifically, the resource guarantees are indexed by a set K, and constraint kϵK is defined by non-negative coefficients (η_{i,k})_{iϵI} and lower and upper limits ξₖ^{min} and ξₖ^{max}, taking the form:

$${ξ}_{k}^{min} \leq {\sum }_{i ∈ I} {η}_{i k} {X}_{i} ( τ ) \leq {ξ}_{k}^{max}$$

at all TTIs, with possibly ξₖ^{min}=0 or ξₖ^{max}=∞.

Note that the slicing constraints are defined with respect to average smooth obtained rates and/or resource amounts and need not be obeyed in each TTI, but over an averaging window that can be tuned through the smoothing parameter δ. Further observe that slices can consist of overlapping sets of users with heterogeneous rate targets and/or resource guarantees.

SMSs can be computed by offsetting Proportional Fair (also other variants with alpha-fair metrics can be implemented) weight and metrics by an additive term given by the token counters associated with rate and resource constraints respectively. The (weighted) PF metric and the additive SMS (SMSa) formulae are defined below.

$$\begin{matrix} {M}_{PF , i} ( τ ) = \frac{{w}_{i} {S}_{i} ( τ )}{{R}_{i} ( τ )} & ( 1 ) \\ {M}_{SMSa , i} ( τ ) = ( \frac{{w}_{i}}{\overline{{R}_{i} ( τ )}} + {\sum }_{j ∈ {J}_{i}} {α}_{j} {β}_{i , j} {Q}_{j} ( τ ) ) {S}_{i} ( τ ) + {\sum }_{j ∈ {J}_{i}} {δ}_{j} {γ}_{i , j} {Z}_{j} ( τ ) & ( 2 ) \\ {Q}_{j} ( τ + 1 ) = \{ \begin{matrix}{Q}_{j} ( τ ) + {\tilde{S}}_{j , min} - {\sum }_{i ∈ {I}_{j}} {β}_{i , j} {S}_{i} ( τ ) & if {Q}_{j} ( τ ) \geq 0 \\ {Q}_{j} ( τ ) + {\tilde{S}}_{j , max} - {\sum }_{i ∈ {I}_{j}} {β}_{i , j} {S}_{i} ( τ ) & if {Q}_{j} ( τ ) < 0\end{matrix} & ( 3 ) \\ {Z}_{j} ( τ + 1 ) = \{ \begin{matrix}{Z}_{j} ( τ ) + {\tilde{X}}_{j , min} - {\sum }_{i ∈ {I}_{j}} {γ}_{i , j} {X}_{i} ( τ ) & if {Z}_{j} ( τ ) \geq 0 \\ {Z}_{j} ( τ ) + {\tilde{X}}_{j , max} - {\sum }_{i ∈ {I}_{j}} {γ}_{i , j} {X}_{i} ( τ ) & if {Z}_{j} ( τ ) < 0\end{matrix} & ( 4 )\end{matrix}$$

where:
Sᵢ(τ): the rate experienced by i-th user/DRB at time τ;
Rᵢ(τ): a measure of the previous average rate experienced by i-th user;
Jᵢ: set of constraints/slices associated with the i-th user; they can represent a Guaranteed Bit Rate (GBR) target for the user, as well as an aggregate GBR/Maximum Bit Rate (MBR) and/or a minimum/maximum resource share for an aggregate of users;
Iⱼ: set of users belonging to the j-th constraint;
Qⱼ(τ): Bit rate token counter value associated with the j-th constraint;
\tilde{S}_{j,min}: Target GBR for the j-th constraint;
\tilde{S}_{j,max}: Target MBR for the j-th constraint;
Zⱼ(τ): physical resource token counter value associated with the j-th constraint;
Xᵢ(τ): amount of physical resources allocated to the i-th user/DRB at time τ;
\tilde{X}_{j,min}: the minimum target physical resources to be allocated to the users belonging to the j-th constraint;
\tilde{X}_{j,max}: the maximum target physical resources to be allocated to the users belonging to the j-th constraint;
wᵢ: a constant weight associated with the i-th user; and
αⱼ, δᵢ, β_{i,j} and γ_{i,j} are coefficients.

For the purpose of the subsequent disclosure relating to ISF, it should be borne in mind that token counters, insofar as they are used, represent how much a constraint has been violated in the past and how much the scheduling metric should be changed to enforce the constraint. In other words, an increment of the token counter represents the difference between an experienced performance and the slice target.

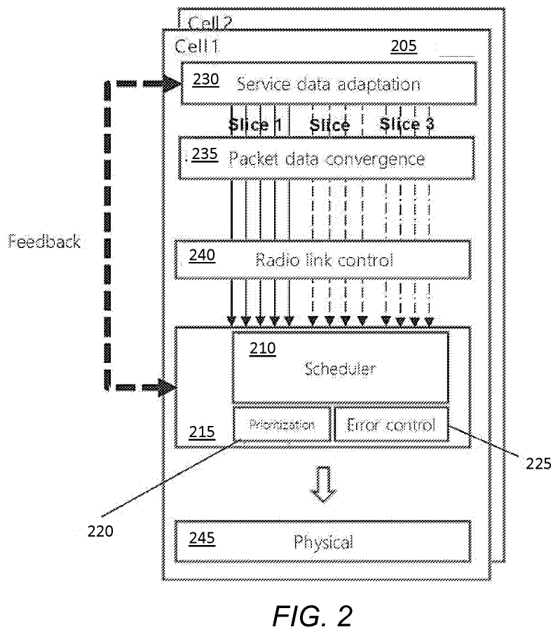

FIG. 2 illustrates an exemplary slicing control scheme according to one or more embodiments described herein. The slicing control scheme may be performed by one or more computing devices, such as a base station (or other access point) serving one or more stations (e.g., mobile user devices) within the base station's cell. A scheduler 210 may be associated with the base station (or a plurality of base stations). For example, the scheduler 210 may be within the base station. The scheduler 210 may be used to schedule packets for transmission to stations. The scheduler 210 may comprise a media access control (MAC) layer scheduler, and may be at the MAC layer 215. The MAC layer 215 may also include, for example, one or more prioritizers 220. The prioritizer(s) 220 may comprise a prioritization multiplexer (MUX)/demultiplexer (DEMUX), such as a logical channel prioritization (LCP) MUX/DEMUX. The MAC layer 215 may also include, for example, one or more error controllers 225, such as hybrid automatic repeat request (HARQ) error controller.

Other layers may be included in the cell 205. For example, a service data adaptation protocol (SDAP) layer 230 may be used to, for example, map flow(s) to DRB(s). The cell 205 may comprise a packet data convergence protocol (PDCP) layer 235. The cell 205 may comprise a radio link control (RLC) layer 240. The cell 205 may comprise a physical (PHY) layer 245. The PHY layer may connect the MAC layer 215 to one or more physical links.

As previously explained, one or more scheduling weights M for transmitting data to stations may be used. The system may generate a scheduling weight for a user based on, for example, a weight factor, a proportional fairness factor, one or more additional weights, and/or a priority offset. For example, for a user i belonging to slice j (and not to other slices), at time, a weight may be determined according to the following exemplary algorithm:

$${M}_{i} ( τ ) = {w}_{i} \cdot {( {R}_{i} ( τ ) )}^{- 1} + {\sum }_{j ∈ {J}_{i}} {α}_{j} {β}_{i , j} {Q}_{j} ( τ ) + {Δ}_{i}$$

wᵢ may correspond to a weight factor. The weight factor may be determined and/or updated (e.g. slowly) by closed-loop control.

((Ri(k))⁻¹ may correspond to a proportional fairness factor. The proportional fairness factor may be determined and/or adjusted by a congestion manager, such as the SDAP 230.

Σ_{jϵJ}_{ᵢ} αⱼβ_{i,j}Qⱼ(τ) may correspond to an additional weight. The token counter Qⱼ(τ) may be tracked and/or determined by a scheduler, such as the MAC scheduler 510.

Δᵢ may correspond to a priority offset. The priority offset may be determined and/or adjusted by a congestion manager, such as SDAP 230.

Messages and/or fields may be used to allow the MAC layer 215 to communicate, with higher layers, information about the performance or behaviour of each slice. Exemplary information may include the token counter value of each slice, which may be shared periodically, e.g., every 100 ms, 200 ms, 1000 ms, etc. This may allow the higher layers to monitor the health of each slice, allowing for interfaces between the MAC layer and higher layers to react to critical conditions and, for example, renegotiate the SLA.

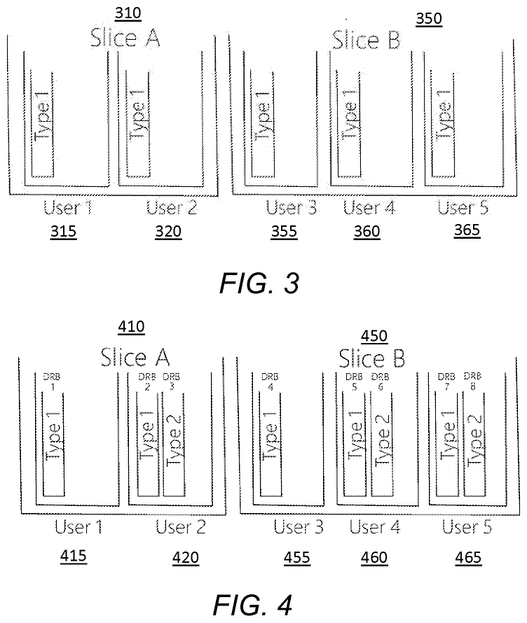

FIG. 3 illustrates an example of adjusting one or more token counters according to one or more embodiments described herein. FIG. 3 illustrates an example with two slices, slice A 310 and slice B 350. Users may be assigned to slices. For example, user 1 315 and user 2 320 may be assigned to slice A 310. User 1 and/or user 2 may communicate via a traffic type 1, such as MBB. User 3 355, user 4 360, and user 5 365 may be assigned to slice B 350. User 3 355, user 4 360, and user 5 365 may also communicate via a traffic type 1, such as MBB. The DRBs may have the same priorities, but be in different slices. Assume, for example, that slice A 310 has an SLA of 200 Mbps. If slice A 310 experiences a transmission rate higher than the SLA, such as 220 Mbps, a token counter Q_{A}(τ) may be decreased (e.g., by the MAC scheduler), such as down to 0. By decreasing the token counter Q_{A}(τ), the weights Mᵢ(τ) for users 1 and 2 belonging to slice A 310 may also decrease. Accordingly, fewer resources may be assigned to slice A 310, freeing up resources to increase the transmission rate of other slices, such as slice B 350 or other slices. Slice B 350 may have, for example, an SLA of 300 Mbps. If slice B 350 experiences a transmission rate lower than the SLA for slice B 350, such as 280 Mbps, a token counter Q_{B}(τ) may be increased (e.g., by the MAC scheduler). By increasing the token counter Q_{B}(τ), the weights Wᵢ(k) for users 3, 4, and 5 belonging to slice B 350 may also increase. Accordingly, additional resources may be assigned to slice B 350 to increase the transmission rate of slice B 350. The resources may be taken from another slice, such as slice A 310. When the SLA for slice B 350 is met, such as the transmission rate for slice B 350 meeting or exceeding the SLA, Q_{B}(τ) may be maintained or decreased.

FIG. 4 illustrates an example of adjusting one or more token counters according to one or more embodiments described herein. In these examples, different types of traffic may be included in each slice. FIG. 4 illustrates an example with two slices, slice A 410 and slice B 450. User 1 415 and user 2 420 may be assigned to slice A 410. User 1 415 may communicate via a traffic type 1, such as MBB. User 2 420 may communicate via a traffic type 1, such as MBB, and via a traffic type 2, such as URLLC. User 3 455, user 4 460, and user 5 465 may be assigned to slice B 450. User 3 455 may communicate via a traffic type 1, such as MBB. User 4 460 and/or user 5 465 may communicate via a traffic type 1, such as MBB, and via a traffic type 2, such as URLLC. As previously explained, slice A 410 may have an SLA of 200 Mbps, and slice B 450 may have an SLA of 300 Mbps. If slice A 410 experiences a transmission rate higher than the SLA, such as 220 Mbps, a token counter Q_{A}(τ) may be decreased (e.g., by the MAC scheduler). On the other hand, if slice B 450 experiences a transmission rate lower than the SLA for slice B 450, such as 280 Mbps, a token counter Q_{B}(τ) may be increased (e.g., by the MAC scheduler).

Moreover, certain types of traffic (e.g., URLLC) may be prioritized over other types of traffic (e.g., MMB). As previously explained, a priority offset Δᵢ may be used to adjust the weight based on priority. For example, the weights for the DRB 1 and DRB 2 for slice A 410 may be determined as follows:

$${M}_{1} ( τ ) = 1 \cdot {( {R}_{i} ( τ ) )}^{- 1} + {\sum }_{j ∈ {J}_{i}} {α}_{1} {β}_{1 , A} {Q}_{A} ( τ ) )$$

$${M}_{2} ( τ ) = 1 \cdot {( {R}_{i} ( τ ) )}^{- 1} + {\sum }_{j ∈ {J}_{i}} {α}_{2} {β}_{1 , A} {Q}_{A} ( τ )$$

The scheduler may decrease Q_{A}(τ) over time because the transmission rate experienced by slice A 410 is higher than the SLA. A weight factor wᵢ may be 1.

The weight for the DRB 3 for slice A 410 may be determined as follows:

$${M}_{3} ( τ ) = 100 \cdot {( {R}_{i} ( τ ) )}^{- 0.5} + {\sum }_{j ∈ {J}_{i}} {α}_{3} {β}_{3 , A} {Q}_{A} ( τ ) ) + {Δ}_{3}$$

The scheduler may decrease Q_{A}(τ) over time because the transmission rate experienced by slice A 410 is higher than the SLA. A weight factor wᵢ may be 100. The proportional fairness factor may be (Rᵢ (τ))^{-0.5} M₃(τ) may also factor (e.g. add) in the priority offset Δ₃ because DRB 3 may carry higher priority traffic (e.g. URLLC traffic).

The weights for the DRB 4, DRB 5, and DRB 7 for slice B 450 may be determined, respectively, as follows:

$${M}_{4} ( τ ) = 1 \cdot {( {R}_{i} ( τ ) )}^{- 1} + {\sum }_{j ∈ {J}_{i}} {α}_{4} {β}_{4 , B} {Q}_{B} ( τ ) \\ {M}_{5} ( τ ) = 1 \cdot {( {R}_{i} ( τ ) )}^{- 1} + {\sum }_{j ∈ {J}_{i}} {α}_{5} {β}_{5 , B} {Q}_{B} ( τ ) )$$

$${M}_{7} ( τ ) = 1 \cdot {( {R}_{i} ( τ ) )}^{- 1} + {\sum }_{j ∈ {J}_{i}} {α}_{7} {β}_{7 , B} {Q}_{B} ( τ )$$

The scheduler may increase Q_{B}(τ) over time because the transmission rate experienced by slice B 450 may be lower than the SLA. A weight factor wᵢ may be 1.

The weight for the DRB 6 and DRB 8 for slice B 450 may be determined, respectively, as follows:

$${M}_{6} ( τ ) = 50 \cdot {( {R}_{i} ( τ ) )}^{- 0.5} + {\sum }_{j ∈ {J}_{i}} {α}_{6} {β}_{6 , B} {Q}_{B} ( τ ) + {Δ}_{6} \\ {M}_{8} ( τ ) = 50 \cdot {( {R}_{i} ( τ ) )}^{- 0.5} + {\sum }_{j ∈ {J}_{i}} {α}_{8} {β}_{8 , B} {Q}_{B} ( τ ) + {Δ}_{8}$$

The scheduler may increase Q_{B}(τ) over time because the transmission rate experienced by slice B 450 may be lower than the SLA. A weight factor wi may be 50. For example, a scheduler parameter manager may determine to use the value 50.

The proportional fairness factor may be (Rᵢ (τ))^{-0.5}.

Congestion management may be used to determine the value −0.5. The weight M₆(τ) may also factor (e.g. add) in the priority offset Δ₆ because DRB 6 may carry higher priority traffic (e.g. URLLC traffic). Similarly, the weight M₈(τ) may factor (e.g. add) in the priority offset Δ₈ because DRB 8 may carry higher priority traffic (e.g. URLLC traffic.) Congestion management may determine the priority offset Δ₆ and/or the priority offset Δ₈. In some examples, minimum/maximum over the guaranteed bit rate, resource share and/or latency may be imposed.

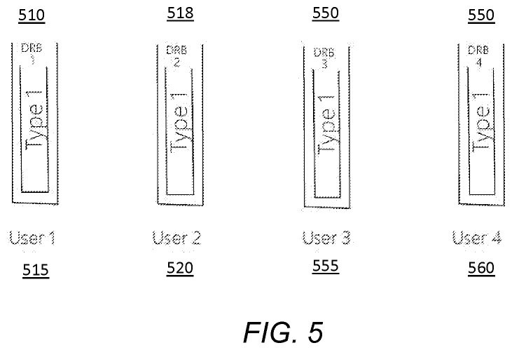

FIG. 5 illustrates an example of adjusting one or more token counters according to one or more embodiments described herein. FIG. 5 illustrates an example with four slices (e.g., slice 510, slice 518, slice 550, and slice 858), and each user (e.g., user 1 515, user 2 520, user 3 555, and/or user 4 560) may be assigned to a different respective slice. Each slice may comprise one or more DRBs for carrying traffic (e.g., DRB 1, DRB 2, DRB 3, and/or DRB 4), so there may be 1 DRB per user. Assume that the traffic for each user is of a traffic type 1, such as MBB. Assume that the SLA for each user is a guaranteed bit rate of 2 Mbps. If user 1's experienced bitrate, is 2.5 Mbps, the token counter Q₁(τ) may be decreased. If user 2's experienced bitrate, is 5 Mbps, the token counter Q₂(τ) may also be decreased. If each of the token counters for slice 510 and slice 518 are set to 0, user 1 and user 2's respective weights M₁(k) and M₂(k) may be determined as follows:

$${M}_{1} ( τ ) = 1 \cdot {( {R}_{1} ( τ ) )}^{- 1} + {\sum }_{j ∈ {J}_{i}} {α}_{1} {β}_{1} {Q}_{1} ( τ ) = {( {R}_{1} ( τ ) )}^{- 1} \\ {M}_{2} ( τ ) = 1 \cdot {( {R}_{2} ( τ ) )}^{- 1} + {\sum }_{j ∈ {J}_{i}} {α}_{2} {β}_{2} {Q}_{2} ( τ ) = {( {R}_{2} ( τ ) )}^{- 1}$$

If user 3's experienced bitrate, is 0.8 Mbps, the token counter Q₃(τ) may be increased to increase user 3's weight M₃(τ). User 3's weight M₃(τ) may be greater than 0. If user 4's experienced bitrate, is 0.5 Mbps, the token counter Q₄(τ) may be increased to increase user 4's weight M₄(τ). In some examples, User 4's weight M₄(τ) may be greater than user 3's weight M₃(τ), which may be greater than 0. User 3 and user 4's respective weights M₃(τ) and M₄(τ) may be determined as follows:

$${M}_{3} ( τ ) = 1 \cdot {( {R}_{3} ( τ ) )}^{- 1} + {\sum }_{j ∈ {J}_{i}} {α}_{3} {β}_{3} {Q}_{3} ( τ ) \\ {M}_{4} ( τ ) = 1 \cdot {( {R}_{4} ( τ ) )}^{- 1} + {\sum }_{j ∈ {J}_{i}} {α}_{4} {β}_{4} {Q}_{4} ( τ )$$

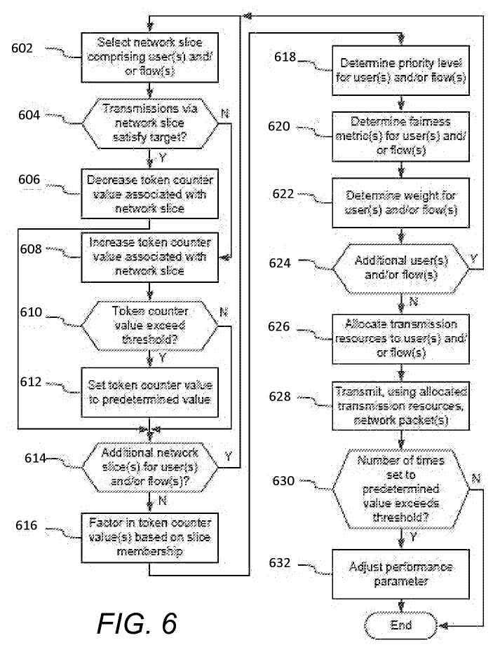

FIG. 6 illustrates an exemplary method of adjusting network slices according to one or more embodiments described herein. One or more of the steps illustrated in FIG. 6 may be performed by a computing device, such as an access node 130 illustrated in FIG. 1 or an apparatus or computing device 1012 illustrated in FIG. 13 (as will be described in further detail below). For example the method may be performed at a base station. The apparatus or computing device may comprise at least one processor and at least one memory including computer program code. The at least one memory and the computer program code may be configured to, with the at least one processor, cause the apparatus or computing device to perform one or more of the steps illustrated in FIG. 6. Additionally or alternatively, a computer-readable medium may store computer-readable instructions that, when executed by a computing device, may cause the computing device to perform one or more of the steps illustrated in FIG. 6.

In step 602, the computing device may select a network slice. As previously described, a network slice may comprise one or more user(s) and/or one or more flow(s). For example, one or more first user devices may be assigned to a first network slice, one or more second user devices may be assigned to a second network slice, and so on. An access node may transmit and/or receive data from each user via one or more of the user's flows. With brief reference to FIG. 4, user 1 415 may have a flow of type 1, which may be mapped to DRB 1. User 2 420 may have a flow of type 1, which may be mapped to DRB 2, and a flow of type 2, which may be mapped to DRB 3. Flows may be of different types, such as mobile broadband flows, ultra-reliable low-latency communication flows, etc. Various other examples of assigning user(s) and/or flow(s) to network slices were previously described.

Returning to FIG. 4, in step 604, the computing device may determine whether transmissions via the selected network slice satisfy one or more targets. As previously explained, targets may comprise bitrate targets, throughput targets, resource share targets, latency targets, or other targets. Longer term performance parameters may be determined by, for example, service level agreements (SLAs). Based on whether transmissions via the network slice satisfy one or more target(s), the computing device may adjust one or more token counter values associated with the network slice. The token counter value(s) may be adjusted (e.g., increased, decreased, or maintained) relative to a previous token counter value for the network slice. Various examples of adjusting the token counter value based on a previous token counter value were previously described.

If transmissions via the network slice do not satisfy target(s) (step 604: N), the computing device may proceed to step 608, as will be described in further detail below. Transmissions might not satisfy targets if, for example, the bitrate experienced by the network slice does not meet or exceed a threshold bitrate, the throughput experienced by the network slice does not meet or exceed a threshold throughput, the resource share obtained by the network slice does not meet a threshold resource share, and/or the latency experienced by the network slice is greater than a threshold latency. If, on the other hand, transmissions via the network slice satisfy target(s) (step 604: Y), the computing device may proceed to step 606.

Transmissions might satisfy targets if, for example, the bitrate experienced by the network slice meets or exceeds a threshold bitrate, the throughput experienced by the network slice meets or exceeds a threshold throughput, the resource share obtained by the network slice meets a threshold resource share, and/or the latency experienced by the network slice is less than or equal to a threshold latency. As previously explained, longer term threshold bitrate, throughput, and/or latency may be indicated in, for example, SLAs.

In step 606, the computing device may decrease the token counter value for the network slice (e.g. relative to a previous token counter value for the network slice) if transmissions via the network slice satisfy target(s). The token counter value may be decreased if, for example, positive token counter values are used. As previously explained, the token counter value may be set to zero (or a different predetermined low value) in some circumstances. Decreasing the token counter value may decrease the weight associated with the user(s) and/or flow(s) of the network slice. Consequently, network resources may be freed up for other network slice(s). If negative token counter values are used, the token counter value may be increased in step 606. The token counter value may be set to zero (or a different predetermined high value) in some circumstances. Increasing the token counter value may decrease the weight associated with the user(s) and/or flow(s) of the network slice. The method may proceed to step 614, as will be described in further detail below.

In step 608, the computing device may increase the token counter value for the network slice (e.g., relative to a previous token counter value for the network slice) if transmissions via the slice do not satisfy target(s). The token counter value may be increased if, for example, positive token counter values are used. Increasing the token counter value may increase the weight associated with the user(s) and/or flow(s) of the network slice. Consequently, more network resources may be used to transmit data via the network slice, which may, for example, increase the bitrate, throughput, resource share, or other performance metric experienced by the network slice. In some examples, the increased token counter value may exceed a threshold token counter value (e.g., a maximum token counter value). If negative token counter values are used, the token counter value may be decreased in step 608 if transmissions via the slice do not satisfy target(s). Decreasing the token counter value may increase the weight associated with the user(s) and/or flow(s) of the network slice.

In step 610, the computing device may determine whether the increased token counter value (e.g., for positive token counter values) would exceed a threshold token counter value or would fall below a threshold token counter value (e.g., for negative token counter values). If not (step 610: N), the method may proceed to step 614, as will be described in further detail below. If, on the other hand, the increased token counter value (e.g., for positive token counter values) would exceed the threshold token counter value or would fall below a threshold token counter value (e.g., for negative token counter values) (step 610: Y), the method may proceed to step 612.

In step 612, the computing device may set the token counter value (e.g., that would have exceeded the threshold token counter value) to a predetermined token counter value. The predetermined token counter value may be, for example, the threshold token counter value or a value less than the threshold token counter value (e.g., for positive token counter values) or a value greater than the threshold token counter value (e.g., for negative token counter values). Thus, in some examples, the token counter value might not exceed (or fall below) a predetermined token counter value, even if target(s) have not been satisfied. The method may proceed to step 614.

In step 614, the computing device may determine whether there are additional network slice(s) for the user(s) and/or flow(s). For example, user(s) and/or flow(s) may be assigned to one or more other network slice(s). As will be described in further detail below, the weight determined for the user(s) and/or flow(s) may be based on one or more tokens associated with slice(s) corresponding to the user(s) and/or flow(s). If there are additional network slice(s) for the user(s) and/or flow(s) (step 614: Y), the method may return to step 602 to identify the additional network slice(s) and/or determine token counter(s) for those additional network slice(s). If there are no additional network slice(s) for the user(s) and/or flow(s) to analyze (step 614: N), the method may proceed to step 616.

In step 616, the computing device may factor in token counter value(s) based on slice membership. As previously explained, a network slice may have one or multiple token counters. If the network slice has one token counter, the computing device may use that token counter value to determine a weight for the flow(s) and/or user(s), as will be described in further detail below. If the network slice has multiple token counters, the computing device may factor in each of the token counter values to determine the weight for the flow(s) and/or user(s). For example, a weighted sum of the token counter values may be used to determine the weight for the flow(s) and/or user(s), as will be described in further detail below.

In step 618, the computing device may determine a priority level for the flow(s) and/or user(s). As previously explained, different types of flows may have different priority levels. For example, URLLC flows may have higher priority levels than MBB flows. A priority offset may be used to determine a weight to use for the flow(s) and/or user(s). For example, the priority offset may increase the weight for higher priority flows and/or decrease the weight for lower priority flows.

In step 620, the computing device may adopt one or more fairness metrics that may be used to determine the weight for the flow(s) and/or user(s). As previously explained, exemplary metrics include, but are not limited to, proportional fairness (PF), maximum throughput (MT), γ-fair, etc.

In step 622, the computing device may determine a weight for the flow(s) and/or user(s). The weight may be determined based on the token counter value for the network slice(s) that the flow(s) and/or user(s) belong to. If there are a plurality of token counter values (e.g., for a plurality of network slices), the weight may be determined based on the plurality of token counter values. Various other factors, such as a priority level for the flow(s) and/or user(s), fairness metrics, and other factors, may be used to determine the weight to assign to the flow(s) and/or user(s).

For example, the weight may be determined according to the following exemplary algorithm:

$${M}_{i} ( τ ) = {w}_{i} \cdot {( {R}_{i} ( τ ) )}^{- 1} + {\sum }_{j ∈ {J}_{i}} {α}_{j} {β}_{i , j} {Q}_{j} ( τ ) + {Δ}_{i}$$

As previously explained, wᵢ may correspond to a weight factor, (Rᵢ (τ)) correspond to a proportional fairness factor, Σ_{jϵJ}_{ᵢ} αⱼβ_{i,j} Qⱼ(τ) may correspond to an additional weight, Qⱼ(τ) may correspond to the token counter value determined for the slice, and Δᵢ may correspond to a priority offset.

In step 624, the computing device may determine whether there are additional users and/or flows to be scheduled. If so (step 624: Y), the computing device may return to step 602 to identify a network slice associated with the additional user and/or flow, determine one or more token counter value(s) for network slices associated with the additional user and/or flow, determine a weight for the additional user and/or flow, etc. If there are no additional users and/or flows to be scheduled (step 624: N), the method may proceed to step 626.

In step 626, the computing device may allocate transmission resources to the various flows and/or users, such as based on the weight determined for each flow and/or user. For example, the computing device may schedule, based on the determined weight(s), transmissions to one or more user devices using the network slice. As previously explained, the computing device may use, for example, a MAC scheduler to adjust token counter value(s) and/or schedule transmissions to user devices. In some examples, the computing device may comprise a base station. Allocating transmission resources may be performed after the token counter values for slices (e.g., all slices) and the weights for flows and/or users (e.g., all flows and/or users) have been determined. The method may proceed to step 628 to transmit network packet(s), such as according to the allocation of transmission resources in step 626.

In step 628, the computing device may transmit, using the allocated transmission resources, network packet(s) to one or more user devices in the corresponding network slice(s). Transmission of networks packets may be performed after the token counter values for slices (e.g., all slices) and the weights for flows and/or users (e.g., all flows and/or users) have been determined. The computing device may continue to monitor whether target(s) for the network slice are satisfied, such as in the transmission and/or future transmissions. Token counter values, weights, and other parameters may be adjusted based on whether target(s) for the network slice are satisfied. For example, one or more of the steps previously described and illustrated in FIG. 6 may be repeated for the network slices and users and/or flows, and the computing device may allocate network resources to the various flows and/or users accordingly.

In some situations, the computing device may set the token counter value for a particular network slice to a predetermined value (e.g., a maximum value for positive token counter values or a minimum for negative token counter values) multiple times. This may indicate that performance parameters for that network slice may need to be adjusted. In step 630, the computing device may determine the number of times (e.g., within a span of time, such as seconds, or a number of transmissions) that the token counter value for each network slice has been set to the predetermined (e.g., maximum or minimum) token counter value. If the number of times the token counter value has been set to the predetermined value does not exceed a threshold number of times (step 630: N), the method may end or may repeat one or more of the steps illustrated in FIG. 6 to adjust token counter values, weights, and other parameters for future resource allocations and/or transmissions. If, on the other hand, the number of times the token counter value has been set to the predetermined token counter value exceeds the threshold number of times (step 630: Y), the method may proceed to step 632.

In step 632, the computing device may adjust a performance requirement parameter for the network slice, such as based on a determination that token counter values associated with the network slice match the predetermined token counter value at least a threshold number of times. A minimum bitrate for the slice may be lowered, a minimum throughput for the slice may be lowered, latency requirements may be relaxed, and/or other performance requirement parameters may be adjusted. For example, a service level agreement may be adjusted. Additionally or alternatively, admission control/overload control (AC/OC) procedures may also be triggered, as previously explained. Once the computing device determines an appropriate token counter value for the slice, the computing device may use the token counter value and other values to determine a weight to use for each flow and/or user.

Scheduling Metrics for Slicing (SMSm) with Intra-Slice Fairness (ISF)

In some example embodiments, the SMSa metric as defined and explained above may be used, adapted and/or modified to provide the desirable properties of ISF. We will refer to this metric as SMSm to distinguish it from SMSa, and also because, in some embodiments, it uses a multiplicative rather than an additive offset. However, the use of multiplicative offsets may not be required in all embodiments.

As mentioned previously, ISF aims to ensure that users or user devices belonging to the same slice, or set of slices, should receive a resource allocation that is substantially proportional to their per-user weights.

Example embodiments employ a scheduling metric SMSm to be used in order to achieve, or approach, both slice-aware scheduling with real-time feasibility, like SMSa, and also achieving, or approaching (ii) ISF.

Example embodiments effectively work by pulling every offset given by, for example the token counters as described above for SMSa, and isolating them from the old used metric for scheduling Mᵢ(τ), that can be any between PF, α-fair metric, or maximum throughput scheduling. In other words, the offset(s) is or are incorporated as part of the metric and are independent of the type of metric or utility function used.

In a first example, the tokens are inserted in the metric as a joint multiplicative offset.

A first general formula can be expressed as

M_{SMSm,i}^{gen}(τ)=ƒ(Mᵢ(τ),Oᵢ^{gen}(τ))

where ƒ(Mᵢ(τ), Oᵢ^{gen} (τ)) is a function that applies the token counter offsets of all constraints jϵJᵢ, and Oᵢ^{gen} (τ)=g({Qⱼᵢ(τ)}_{jϵJ}_{ᵢ}, {Zⱼᵢ(τ)_{jϵJ}_{ᵢ}}) a function of all tokens of constraints jϵJᵢ.

The general formula is specified in the SMSm algorithm to accept per-user and per-slice QoS constraints and to deliver them by proper multiplicative offsets of the users' scheduling weight/metrics. In some example embodiments, the multiplicative offset may be the multiplicative combination of terms related to each constraint active for the considered user.

For example:

ƒ(Mᵢ(τ), O_{SMSm,i}^{gen}(τ))=Mᵢ(τ)·O_{SMSm,i}^{gen}(τ), while g({Qⱼ(τ)}_{jϵJ}_{ᵢ}, {Zⱼ(τ)}_{jϵJ}_{ᵢ}) is defined below.

In this equation,

$${M}_{S M S m , i}^{g e n} ( τ ) = {M}_{i} ( τ ) \cdot {O}_{S M S m , i}^{g e n} ( τ ) \\ {O}_{S M S m , i}^{g e n} ( τ ) = {\prod }_{j ∈ {J}_{i}} {O}_{S M S m , j}^{g e n} ( τ ) \\ {O}_{S M S m , j}^{g e n} ( τ + 1 ) = h ( {O}_{S M S m , j} ( τ ) , S ( τ ) , X ( τ ) , C ) \qquad ( 5 )$$

where
M_i(τ) is a state-of-the-art slice-unaware metric, e.g. PF as defined previously in (1).
O_{SMSm,i} (τ) is the multiplicative offset of user i
O_{SMSm,j} (τ) is the multiplicative offset of constraint j
h(O_{SMSm,j}(τ), S(τ), X(τ), C) is some function such that O_{SMSm,j}^{gen}(τ+1) is larger than O_{SMSm,j} (τ) when \tilde{S}_{j,min}−Σ_{iϵI}_{ⱼ}β′_{i,j}Sᵢ(τ) and Qⱼ (τ) are positive and \tilde{X}_{j,min}−Σ_{iϵI}_{ⱼ} Y′_{i,j}Xᵢ(τ) and Zⱼ(τ) are positive, and smaller than O_{SMSm,j} (τ) when \tilde{S}_{j,max}−Σ_{iϵI}_{ⱼ}β′_{i,j}Sᵢ(τ) and Qⱼ(τ) are negative and \tilde{X}_{j,max}−Σ_{iϵI}_{ⱼ}γ′_{i,j}Xᵢ(τ) and Zⱼ(τ) are negative.

Thus, the updates or adjustments of the offset or offsets are given by a function which is based on the previous offset and the set of users' achieved rates S(τ), resources X(τ), and target constraints.

An example proposal for the SMSm metric is below

M_{SMSm,i}(τ)=Mᵢ(τ)·a^{(Σ}^{_{jϵJi}}^{(α′}^{ⱼ}^{β′}^{_{i,j}}^{Q}^{ⱼ}^{(τ)+δ′}^{ⱼ}^{γ′}^{_{i,j}}^{z}^{ⱼ}^{(τ)))}=Mᵢ(τ)·O_{SMSm,i}(τ) (6)

where a>1 is a generic real parameter. The metric may then be specialized to a (weighted) PF scheduler as follows:

$${M}_{SMSm , i}^{PF} ( τ ) = \frac{{w}_{i} {R}_{i} ( τ )}{\overline{{R}_{ι}} ( τ )} {a}^{( {\sum }_{j ∈ {J}_{i}} ( {α}_{j}^{′} {β}_{i , j}^{′} {Q}_{j} ( τ ) + {δ}_{j}^{′} {γ}_{i , j}^{′} {Z}_{j} ( τ ) ) )} = {M}_{PF , i} ( τ ) \cdot {O}_{SMSm , i} ( τ ) \qquad ( 7 )$$

As defined above, with SMSm we have:

g({Qⱼ(τ)}_{jϵJ}_{ᵢ}₎,{Zⱼ(τ)}_{jϵJ}_{ᵢ})=a^{(Σ}^{_{jϵJi}}^{(α′}^{ⱼ}^{β′}^{_{i,j}}^{Q}^{ⱼ}^{(τ)+δ′}^{ⱼ}^{γ′}^{_{i,j}}^{z}^{ⱼ}^{(τ)))}.

Note that example embodiments can also be used in the context of 4G-5G resource splitting and allocation, where targets on the average split are defined by the system designer.

In an example embodiment, as was done for SMSa, the token counters in SMSm may be capped to a minimum or maximum value, to allow the system to handle non-full buffer traffic transmissions or incompatible/infeasible slicing constraints.

As will be explained below, with reference to system level simulations, SMSm may not provide optimal performance compared with SMSa, but provides the benefit of the desired ISF property.

Reasons why SMSm may guarantee ISF will now be explained.

Since the i-th user SMSm offset O_{SMSm,i} (τ) depends only on the subset of slices Jᵢ that i belongs to, we can easily write that if Jᵢ=J_{i′}, then O_{SMSm,i} (τ)=O_{SMSm,i′}(τ) ∀τ. In other words, any set of users that belong to the same slice (or set of slices) have the same multiplicative offset relative to their respective standard (weighted) PF metrics as defined above. Thus, the scheduling arbitration among these users is not affected by the common multiplicative offset and governed by the standard (weighted) PF metrics. This in turn implies that SMSm may inherit the approximate weight-proportionality properties of the standard PF scheduler and, in particular, users that have the same constant weight and belong to the same slice (or set of slices) may receive roughly the same resource allocation, providing intra-slice fairness as claimed.

Performance Evaluation of SMSm

The performance of the SMSm scheme has been evaluated in a 3GPP calibrated system-level simulator, with the parameters reported in Table 1.

TABLE I
General Simulation Parameters

| | |
|---|---|
| General Environment | 3GPP 3D UMa Scenario |
| Number of 120° Cells | 3 Cells, Wraparound interference) |
| Simulation Time | 10 s (after 1 s bootstrap time), 200 |
| | experiments |
| Slice-Member Users in the | 18 |
| system (MG1) | |
| Best Effort Users in the system | 24 |
| (MG2) | |
| Traffic Model | Full Buffer (FB)/Constant Bit Rate |
| | (CBR) |
| CBR Packet Arrival Time | 20 ms |
| CBR Packet Dimension | CBR GBR * 20 ms |
| CQI Model | Pilot-based, sub-band reports |
| | every 5 ms |
| Subcarrier Spacing | 15 kHz |
| TTI | 1 ms |
| Bandwidth | 10 MHz = 48 PRBs |
| SRU (Schedulable Resource Unit) | 3 PRBs → 48/3 = 16 SRUs |
| gNB Antennas | 2 Vertically polarized |
| User Antennas | 2 Vertically polarized |
| User Mobility | 3 km/h |
| Link to System-Level Model | MIESM |

SMSa and SMSm work for all kinds of constraints related to min/max bit rate targets and min/max resource constraints for users or group of users (per slice). Results may be provided for many considered scenarios, but here we analyze and compare the performance of SMSa and SMSm in the case of aggregate minimum bit rate targets for users of a slice in a cell that we refer to as MG1.

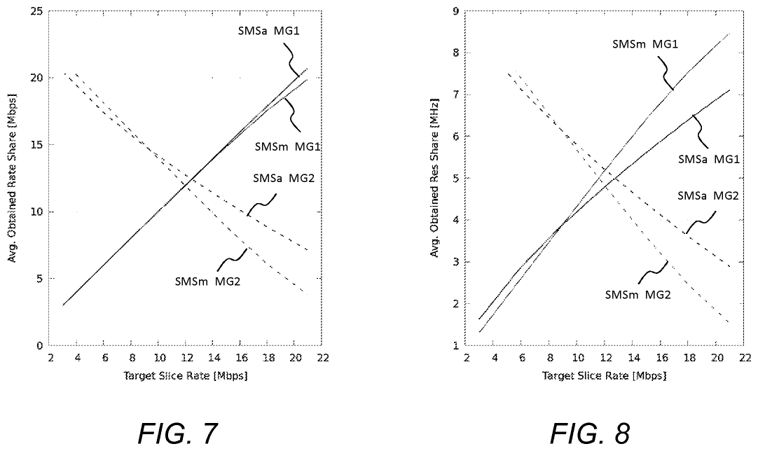

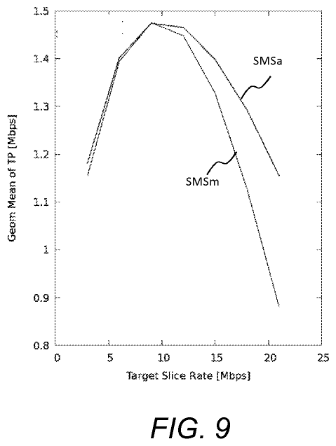

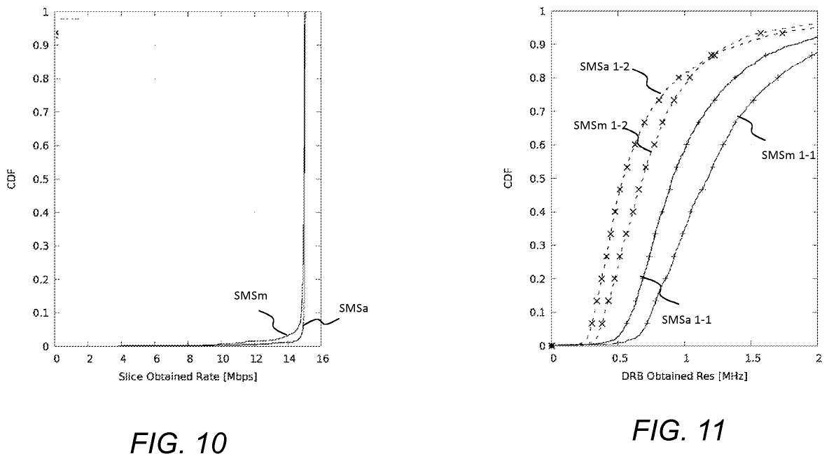

FIG. 7 is a graph indicating average obtained rate share (Mbps) versus target slice rate (Mbps). Referring to FIG. 7, it will be seen that both algorithms are able to deliver the desired aggregated bit rate, on average. In particular, SMSa is able to push and deliver the target to higher rates than SMSm (e.g. see 20 Mbps target, where SMSa is able to match it, while SMSm cannot). With reference to FIG. 8, indicating average obtained rate share (Mhz) versus target slice rate (Mbps), it is seen that for high targets, SMSm consumes more resources, while SMSa optimizes the PF objective function, e.g. the geometric mean of throughput (GMT), subject to the aggregate bit rate constraint only. SMSm has the additional constraint of ISF. The impact of the ISF constraint can be observed by measuring the GMT of the SMSa and SMSm algorithms, for which refer to FIG. 9. FIG. 9 indicates GMT (Mbps) versus the target slice rate (Mbps.) It is seen that SMSa is able to satisfy the rate target in few more cells than SMSm, as indicated in FIG. 10, which shows a cumulative distribution function (CDF) versus slice obtained rate (Mbps) graph. This is because SMSa does not take ISF into account, and can achieve more stringent targets in terms of rate by allocating more resources to users or user devices with good spectral efficiency, enabling achievement of the target by, for example, penalizing users with poor spectral efficiencies.

On the other hand, SMSm imposes the constraint of ISF, leading to a small price to pay in terms of achievable GMT, but nevertheless guaranteeing the desired ISF and enabling desirably properties of (weighted) PF where resources are allocated roughly in proportion to the user-specific constant weights wᵢ.

An example can be seen in the graph of FIG. 11, where users of the MG 1 slice are split in two sub-slices, MG 1-1 and MG 1-2 with weights “2” and “1” respectively. While distributions of SMSm are assuming values one the double of the other, SMSa delivers that only on average but diverges, especially at high quantiles.

In another example embodiment, a different possible implementation of SMSm from the one described above can be applied. There are found to be no changes with respect to the effects and performance. As explained above, because the offset O_{SMS,i} (τ) depends on the token counters in formulae (3) and (4), it can be easily shown that the offset can be computed either as a whole with the token counter values, as is done in formulae (6) and (7), or by taking the previous value O_{SMS,i} (τ−1) and multiplying it with a term depending on how much the slice constraint is satisfied or not satisfied at a time TTI τ, as follows:

$${O}_{SMSm , i}^{gen} ( τ + 1 ) = {O}_{SMSm , i}^{gen} ( τ ) \cdot {\prod }_{j ∈ {J}_{i}} {Δ}_{SMSm , \{ ij \}}^{gen} ( τ ) \\ {Δ}_{SMSm , \{ ij \}}^{gen} ( τ ) = {Δ}_{SMSm , \{ ij \}}^{rate , gen} ( τ ) \cdot {Δ}_{SMSm , \{ ij \}}^{res , gen} ( τ ) \qquad ( 8 )$$

where Δ_{SMSm,j}^{rate}(τ+1) is a function that is larger than 1 when \tilde{S}_{j,min}−Σ_{iϵI}_{ⱼ}β′_{i,j}Sᵢ(τ), and Qⱼ(τ) are positive and smaller than 1 when \tilde{S}_{j,max}−Σ_{iϵI}_{ⱼ}β′_{i,j}Sᵢ(τ) and Qⱼ(τ) are negative. Δ_{SMSm,j}^{res}(τ+1) is a function that is larger than 1 when \tilde{X}_{j,min}−Σ_{iϵI}_{ⱼ}γ′_{i,j}Xᵢ(τ) and Zⱼ (τ) are positive and smaller than 1 when \tilde{X}_{j,max}−Σ_{iϵI}_{ⱼ}γ′_{i,j}Xᵢ(τ) are negative.

For example,

$${Δ}_{SMSm , \{ ij \}}^{rate} ( τ + 1 ) = \{ \begin{matrix}pow ( b , {α}_{j}^{′} {β}_{i , j}^{′} ( {\tilde{S}}_{j , min} - {\sum }_{i ∈ {I}_{j}} {β}_{i , j}^{′} {S}_{i} ( τ ) ) ) & if {Q}_{j} ( τ ) \geq 0 \\ pow ( b , {α}_{j}^{′} {β}_{i , j}^{′} ( {\tilde{S}}_{j , max} - {\sum }_{i ∈ {I}_{j}} {β}_{i , j}^{′} {S}_{i} ( τ ) ) ) & if {Q}_{j} ( τ ) < 0\end{matrix} \\ {Δ}_{SMSm , \{ ij \}}^{res} ( τ + 1 ) = \{ \begin{matrix}pow ( b , {δ}_{j}^{′} {γ}_{i , j}^{′} ( {\tilde{X}}_{j , min} - {\sum }_{i ∈ {I}_{j}} {γ}_{i , j}^{′} {X}_{i} ( τ ) ) ) & if {Z}_{j} ( τ ) \geq 0 \\ pow ( b , {δ}_{j}^{′} {γ}_{i , j}^{′} ( {\tilde{X}}_{j , max} - {\sum }_{i ∈ {I}_{j}} {γ}_{i , j}^{′} {X}_{i} ( τ ) ) ) & if {Z}_{j} ( τ ) < 0\end{matrix}$$

where pow(a, b)=a^{b}.

Viewed from this perspective, SMSm can be seen as an algorithm that tries to achieve the optimal weights by means of multiplicative weight adjustments.

In accordance with another example embodiment, which may be referred to as proportional control (PC), the updates may be regulated by a multiplicative term proportional to the ratio of the target performance and the experienced one.

PC specializes the general update formula (8) as follows

$${Δ}_{SMSm , \{ ij \}}^{rate , gen} ( τ + 1 ) = {Δ}_{SMSm , j}^{rate , PC} ( τ + 1 ) = {( \frac{{\tilde{S}}_{j}}{( {\sum }_{i ∈ {I}_{j}} {β}_{i , j}^{′} {S}_{i} ( τ ) + {χ}_{j} )} )}^{{ξ}_{j}}$$

$${Δ}_{SMSm , \{ ij \}}^{res , PC} ( τ + 1 ) = {Δ}_{SMSm , j}^{res , PC} ( τ + 1 ) = {( \frac{{\tilde{X}}_{j}}{( {\sum }_{i ∈ {I}_{j}} {γ}_{i , j}^{′} {X}_{i} ( τ ) + {χ}_{j} )} )}^{{ξ}_{j}}$$

where
χⱼ and ξⱼ are parameters that can be set to regulate some numerical properties about convergence; and
\tilde{S}ⱼ and \tilde{X}ⱼ are target (min=max) rate and resource share for constraint j.

An extension to accept minimum and maximum constraints is trivial and can be based on the formulation of (8), where

$${O}_{SMSm , j}^{rate , PC} ( τ ) = {Π}_{τ} {Δ}_{SMSm , j}^{rate , PC} ( τ ) , and$$

$${O}_{SMSm , j}^{res , PC} ( τ ) = {Π}_{τ} {Δ}_{SMSm , j}^{res , PC} ( τ ) , \\ {Δ}_{SMSm , j}^{rate , PC} ( τ + 1 ) = \{ \begin{matrix}{( \frac{{\tilde{S}}_{j , min}}{( {\sum }_{i ∈ {I}_{j}} {β}_{i , j}^{′} {S}_{i} ( τ ) + {χ}_{j} )} )}^{{ξ}_{j}} & if {O}_{SMSm , j}^{rate , PC} ( τ ) \geq 1 \\ {( \frac{{\tilde{S}}_{j , maz}}{( {\sum }_{i ∈ {I}_{j}} {β}_{i , j}^{′} {S}_{i} ( τ ) + {χ}_{j} )} )}^{{ξ}_{j}} & if {O}_{SMSm , j}^{rate , PC} ( τ ) \geq 1\end{matrix} \\ {Δ}_{SMSm , \{ ij \}}^{res , PC} ( τ + 1 ) = \{ \begin{matrix}{( \frac{{\tilde{X}}_{j , min}}{( {\sum }_{i ∈ {I}_{j}} {γ}_{i , j}^{′} {X}_{i} ( τ ) + {χ}_{j} )} )}^{{ξ}_{j}} & if {O}_{SMSm , j}^{res , PC} ( τ ) \geq 1 \\ {( \frac{{\tilde{X}}_{j , maz}}{( {\sum }_{i ∈ {I}_{j}} {γ}_{i , j}^{′} {X}_{i} ( τ ) + {χ}_{j} )} )}^{{ξ}_{j}} & if {O}_{SMSm , j}^{res , PC} ( τ ) \geq 1\end{matrix}$$

Another example embodiment for providing slice-aware scheduling, whilst preserving ISF, comprises applying the token counters as additive offsets to the scheduling metric.

Therefore, we may now have:
M_{i,AO} (τ)=ƒ(Mᵢ(τ), O_{i,AO}(τ))=Mᵢ(τ)+O_{i,AO}(τ),
O_{i,AO}(Z)=Σ_{jϵJ}_{ᵢ}(α″ⱼβ″_{i,j}Qⱼ(τ)+δ″ⱼγ″_{i,j}Zⱼ(τ))
The token counters Qⱼ(τ) and Zⱼ(τ) are updated as in the above-described SMSa/SMSm algorithms.

It will be noted that this particular embodiment involves no multiplication or exponential operations, offering benefits in terms of numerical stability and/or testing.

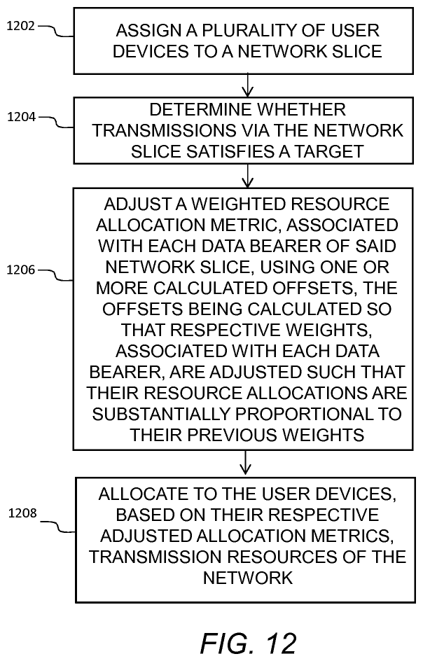

FIG. 12 is a flow diagram illustrating processing operations of example embodiments that may be performed in hardware, software, firmware or a combination thereof.

A first operation 1202 may comprise assigning a plurality of user devices, flows and/or data bearers to a network slice of a plurality of network slices.

A second operation 1204 may comprise determining whether transmissions via the network slice satisfy a target.

A third operation 1206 may comprise adjusting a weighted resource allocation metric associated with each user device, flow or data bearer of said network slice using one or more calculated offsets, the offsets being calculated so that respective weights, associated with each user device, flow or data bearer, are adjusted such that their resource allocations are substantially proportional to their previous weights.

A fourth operation 1208 may comprise allocating to the user devices, based on their respective adjusted weighted resource allocation metrics, transmission resources of the network.

It will be appreciated that additional operations may be added, or operations may be modified, without departing from the scope. The order of reference numerals is not necessarily indicative of the order of processing.

The aforementioned operations can be realised in any suitable manner, one of which is described below, and for abovementioned reasons and justifications offers a way of allocating network resources, not only to achieve or approach a particular allocation metric, but also to provide substantial ISF.

FIG. 13 illustrates an example apparatus, in particular a computing device 1012, that may be used in a communication network such as the one illustrated in FIG. 1, to implement any or all of stations 105, 110, 115, 120, and/or AP 130, to perform the steps, data transmissions, and data receptions illustrated in, and described with reference to, previous Figures. Computing device 1012 may be provided in a base station, eNB or gNB for example a RAN base station. Computing device 1012 may include a controller 1025. The controller 1025 may be connected to a user interface control 1030, display 1036 and/or other elements as illustrated. Controller 1025 may include circuitry, such as for example one or more processors 1028 and one or more memory 1034 storing software 1040. The software 1040 may comprise, for example, one or more of the following software options: client software 165, user interface software, server software, etc.

Device 1012 may also include a battery 1050 or other power supply device, speaker 1053, and one or more antennae 1054. Device 1012 may include user interface circuitry, such as user interface control 1030. User interface control 1030 may include controllers or adapters, and other circuitry, configured to receive input from or provide output to a keypad, touch screen, voice interface—for example via microphone 1056, function keys, joystick, data glove, mouse and the like. The user interface circuitry and user interface software may be configured to facilitate user control of at least some functions of device 1012 though use of a display 1036. Display 1036 may be configured to display at least a portion of a user interface of device 1012. Additionally, the display may be configured to facilitate user control of at least some functions of the device (for example, display 1036 could be a touch screen).

Software 1040 may be stored within memory 1034 to provide instructions to processor 1028 such that when the instructions are executed, processor 1028, device 1012 and/or other components of device 1012 are caused to perform various functions or methods such as those described herein. The software may comprise machine executable instructions and data used by processor 1028 and other components of computing device 1012 may be stored in a storage facility such as memory 1034 and/or in hardware logic in an integrated circuit, ASIC, etc. Software may include both applications and operating system software, and may include code segments, instructions, applets, pre-compiled code, compiled code, computer programs, program modules, engines, program logic, and combinations thereof.

Memory 1034 may include any of various types of tangible machine-readable storage medium, including one or more of the following types of storage devices: read only memory (ROM) modules, random access memory (RAM) modules, magnetic tape, magnetic discs (for example, a fixed hard disk drive or a removable floppy disk), optical disk (for example, a CD-ROM disc, a CD-RW disc, a DVD disc), flash memory, and EEPROM memory. As used herein (including the claims), a tangible or non-transitory machine-readable storage medium is a physical structure that may be touched by a human. A signal would not by itself constitute a tangible or non-transitory machine-readable storage medium, although other embodiments may include signals or ephemeral versions of instructions executable by one or more processors to carry out one or more of the operations described herein.

As used herein, processor 1028 (and any other processor or computer described herein) may include any of various types of processors whether used alone or in combination with executable instructions stored in a memory or other computer-readable storage medium. Processors should be understood to encompass any of various types of computing structures including, but not limited to, one or more microprocessors, special-purpose computer chips, field-programmable gate arrays (FPGAs), controllers, application-specific integrated circuits (ASICs), combinations of hardware/firmware/software, or other special or general-purpose processing circuitry.

As used in this application, the term ‘circuitry’ may refer to any of the following: (a) hardware-only circuit implementations (such as implementations in only analog and/or digital circuitry) and (b) combinations of circuits and software (and/or firmware), such as (as applicable): (i) a combination of processor(s) or (ii) portions of processor(s)/software (including digital signal processor(s)), software, and memory(ies) that work together to cause an apparatus, such as a mobile phone or server, to perform various functions) and (c) circuits, such as a microprocessor(s) or a portion of a microprocessor(s), that require software or firmware for operation, even if the software or firmware is not physically present.

These examples of ‘circuitry’ apply to all uses of this term in this application, including in any claims. As an example, as used in this application, the term “circuitry” would also cover an implementation of merely a processor (or multiple processors) or portion of a processor and its (or their) accompanying software and/or firmware. The term “circuitry” would also cover, for example, a baseband integrated circuit or applications processor integrated circuit for a mobile phone or a similar integrated circuit in a server, a cellular network device, or other network device

Device 1012 or its various components may be mobile and be configured to receive, decode and process various types of transmissions including transmissions in Wi-Fi networks according to a wireless local area network (e.g., the IEEE 802.11 WLAN standards 802.11n, 802.11ac, etc.) and/or wireless metro area network (WMAN) standards (e.g., 802.16), through a specific one or more WLAN transceivers 1043, one or more WMAN transceivers 1041. Additionally or alternatively, device 1012 may be configured to receive, decode and process transmissions through various other transceivers, such as FM/AM Radio transceiver 1042, and telecommunications transceiver 1044 (e.g., cellular network receiver such as CDMA, GSM, 4G LTE, 5G, etc.).

Although specific examples of carrying out the invention have been described, those skilled in the art will appreciate that there are numerous variations and permutations of the above-described systems and methods that are contained within the spirit and scope of the invention as set forth in the appended claims. For example, embodiments of the invention may be applied to various wireless access systems, such as, OFDMA.

1-25. (canceled)

26. An apparatus, comprising means for:
determining whether transmissions via a network slice of a plurality of network slices satisfy a target;
based on determining whether transmissions via the network slice satisfy the target, adjusting a weighted resource allocation metric associated with one or more data bearers on said network slice using one or more calculated offsets, the offsets being calculated so that respective weights, associated with each data bearer on said network slice, are adjusted such that their resource allocations are substantially proportional to their associated weight; and
allocating to the data bearers, based on their respective adjusted weighted resource allocation metrics, transmission resources of the network.

27. The apparatus of claim 26, wherein the means is configured to adjust the resource allocation metric, associated with each data bearer, based on adjusting the weights of each data bearer on said network slice using the same multiplicative factor.

28. The apparatus of claim 27, wherein the target is associated with a constraint for the network slice, and the multiplicative factor comprises at least an offset associated with the constraint.

29. The apparatus of claim 28, wherein the means is configured to determine whether transmissions via the network slice satisfy a plurality of targets, each relating to a respective constraint for the network slice, and wherein a plurality of respective multiplicative offsets are provided, associated with said constraints.

30. The apparatus of claim 27, wherein the means is further configured to determine the amount by which the one or more targets is or are satisfied or not satisfied at a current time, and to determine the one or more multiplicative offsets based on the amount by which the one or more targets is or are satisfied or not satisfied at the current time.

31. The apparatus of claim 27, wherein the means is further configured, based on determining whether transmissions via the network slice satisfy the target, to adjust a token counter value associated with the network slice, wherein adjusting the token counter value is based on a previous token counter value associated with the network slice, and to calculate the one or more offsets based on the updated token counter values.

32. The apparatus of claim 27, wherein the means is further configured to calculate the one or more multiplicative offsets, such that they are substantially proportional to the ratio of the respective target or targets and the performance experienced by the data bearers in relation to the target or targets.

33. The apparatus of claim 26, wherein the means is further configured to transmit, to the data bearers and using the allocated transmission resources, one or more network packets.

34. The apparatus of claim 26, wherein the weighted resource allocation metric is a proportional fairness metric; and
wherein the target or targets comprises one or more of a bit rate target, a throughput target, a latency target and a resource share target.

35. The apparatus of claim 26, wherein the means comprises:
at least one processor; and
at least one memory including computer program code.

36. A method, comprising:
determining whether transmissions via a network slice of a plurality of network slices satisfy a target;
based on determining whether transmissions via the network slice satisfy the target, adjusting a weighted resource allocation metric associated with one or more data bearers on said network slice using one or more calculated offsets, the offsets being calculated so that respective weights, associated with each data bearer on said network slice, are adjusted such that their resource allocations are substantially proportional to their associated weight; and
allocating to the data bearers, based on their respective adjusted weighted resource allocation metrics, transmission resources of the network.

37. The method of claim 36, wherein the resource allocation metric, associated with each data bearer, may be adjusted by adjusting the weights of each data bearer on said network slice using the same multiplicative factor.

38. The method of claim 36, wherein the target is associated with a constraint for the network slice, and the multiplicative factor comprises at least an offset associated with the constraint.

39. The method of claim 38, further comprising determining whether transmissions via the network slice satisfy a plurality of targets, each relating to a respective constraint for the network slice, and wherein a plurality of respective multiplicative offsets are provided, associated with said constraints.

40. The method of claim 38, further comprising determining the amount by which the one or more targets is or are satisfied or not satisfied at a current time, and determining the one or more multiplicative offsets based on the amount by which the one or more targets is or are satisfied or not satisfied at the current time.

41. The method of claim 39, further comprising, based on determining whether transmissions via the network slice satisfy the target, adjusting a token counter value associated with the network slice, wherein adjusting the token counter value is based on a previous token counter value associated with the network slice, and to calculate the one or more offsets based on the updated token counter values.

42. The method of claim 38, further comprising calculating the one or more multiplicative offsets, such that they are substantially proportional to the ratio of the respective target or targets and the performance experienced by the data bearers in relation to the target or targets.

43. The method of claim 36, further comprising transmitting, to the data bearers and using the allocated transmission resources, one or more network packets.

44. The method of claim 36, performed at a base station radio access network (RAN) scheduler.

45. A non-transitory computer-readable medium storing computer-readable instructions that, when executed by a computing device, cause the computing device at least to perform:
determining whether transmissions via a network slice of a plurality of network slices satisfy a target;
based on determining whether transmissions via the network slice satisfy the target, adjusting a weighted resource allocation metric associated with one or more data bearers on said network slice using one or more calculated offsets, the offsets being calculated so that respective weights, associated with each data bearer on said network slice, are adjusted such that their resource allocations are substantially proportional to their associated weight; and
allocating to the data bearers, based on their respective adjusted weighted resource allocation metrics, transmission resources of the network.
